(19) United States
(12) Patent Application Publication
(10) Pub. No.: US 2003/0005328 A1
(43) Pub. Date: Jan. 2, 2003

(54) Dynamic configuration of IPSec tunnels

(76) Inventors: Karanvir Grewal, Mississauga (CA); Cristina Georgescu, North York (CA)

Correspondence Address: Pillsbury Winthrop LLP, 1600 Tysons Blvd., McLean, VA, 22102, US

(21) Appl. No.: 09/893,736

(22) Filed: Jun. 29, 2001

(51) Int. Cl. H04L 9/00

(52) U.S. Cl. 713/201; 713/150

(57) ABSTRACT

A method and system for dynamically configuring a tunnel is presented. A client initiates a negotiation with a gateway. The gateway sends information to the client. The client extracts a security configuration from the information. Using the security configuration, a tunnel is established between the client and the gateway so that secure communication may occur.

### BACKGROUND

1. Field

The present invention relates generally to virtual private networks (VPNs). Specifically, the present invention relates to methods and systems for configuring VPN tunnels.

2. General Background and Related Art

In the age of electronic communications, it is essential that parties communicate with each other in a secure, protected manner. Absent appropriate security measures, external parties may gain access to information exchanged between communicating parties. Such access may compromise both public and private interests.

Security technologies have emerged to address problems inherent in electronic exchanges of information. For example, a virtual private network (VPN) is a secure network connection within a network. Specifically, a VPN “tunnel” is a secure connection established between endpoints in a network. All data exchanged between a node at a first endpoint and a node at a second endpoint is subject to some kind of security manipulation, such as encryption. As such, an external party may not gain access to the data exchanged. Nodes may be geographically remote, separated by many intervening switches and routers.

To establish a VPN tunnel, an initiator and a responder may participate in a series of negotiations. The initiator may initiate a negotiation with the responder. During the negotiation, information may be exchanged between the nodes that sets forth security policies applicable to future exchanges of information. Where several phases of negotiation occur, a secure set of defining parameters may be generated. Thus, a tunnel may be established, and the initiator and the responder may communicate in a secure manner.

Protocols govern the process of establishing tunnels between nodes. Specifically, IPSec, RFC 2401, 2411, is a set of extensions to the IP protocol family that enables the creation of encrypted tunnels. IPSec provides cryptographic security services, including authentication, integrity, access control, and confidentiality support. IPSec is transparent to network applications. The protocols and rules governing IPSec transmissions must conform to documents promulgated by Internet working groups.

IPSec includes a number of protocols, including Authentication Header (AH), RFC 2402, and ESP (Encapsulated Security Payload), RFC 2406. IPSec-secured links are defined in terms of security associations (SAs), RFC 2408. An SA is a security configuration that includes information required for execution of various network security services. In particular, an SA may include security attributes, such as network parameters and network addresses. Each SA is defined for a single unidirectional flow of data, usually from a single node to another node, and covers traffic distinguishable by some unique selector. The applicable security protocol for SAs may be AH or ESP. The AH follows a basic IP header and contains cryptographic hashes of the data as well as identification information. The ESP header allows for rewriting of the payload in encrypted form.

FIG. 1 (Prior Art) depicts a system in which a tunnel may be established. System 100 includes a client 120 and a gateway 180 which communicate with each other over the Internet 160. Client 120 stores the IP address 130 of gateway 180. Client 120 also stores a security configuration 140. Similarly, gateway 180 stores a security configuration 170.

In order to establish a tunnel 150 between client 120 and gateway 180, client 120 may initiate a preliminary negotiation with gateway 180. In this preliminary negotiation, client 120 and gateway 180 may agree upon a security algorithm to use in subsequent negotiations. In the IPSec protocol, this preliminary negotiation is termed phase1 negotiation. After phase1 negotiation, client 120 may initiate another negotiation with gateway 180. In what is termed phase2, client 120 and gateway 180 generate secure keys to define subsequent secure transmissions between client 120 and gateway 180 over tunnel 150.

Phase2 negotiation only succeeds if gateway 180 and client 120 are identically configured. That is, to establish tunnel 150, security configuration 170 in gateway 180 must be identical to security configuration 140 in client 120. If even a slight difference exists between the respective security configurations, phase2 negotiation fails.

Accordingly, a client administrator 101 must configure parameters within security configuration 140. Similarly, a gateway administrator 110 must configure security parameters within security configuration 170. This configuration process is complex, and client administrator 101 must know the respective security configuration of every endpoint with which client 120 seeks to establish a tunnel. Moreover, when gateway administrator 110 alters even one parameter within security configuration 170 of gateway 180, client administrator 101 must modify the counterpart parameter within security configuration 140 of client 120. FIG. 2 (Prior Art) depicts exemplary security configurations that may be associated with client 120 and gateway 180 in FIG. 1.

Therefore, what is needed is a method and system for dynamically configuring tunnels in a network.

### BRIEF DESCRIPTION OF THE DRAWINGS

FIG. 1 (Prior Art) illustrates a system in which a tunnel may be established.

FIG. 2 (Prior Art) depicts security configurations that may be associated with a client and a gateway in the system of FIG. 1.

FIG. 3 illustrates a system according to an embodiment of the present invention.

FIG. 4 is a high-level flow diagram of a method according to an embodiment of the present invention.

FIG. 5 is a high-level flow diagram of a method according to an embodiment of the present invention.

FIG. 6 is a high-level flow diagram of a method according to an embodiment of the present invention.

FIG. 7 illustrates an exemplary Configuration Mode Exchange transaction.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A method and system for dynamically configuring a tunnel, as presented herein, involves a client and a gateway. The client initiates a negotiation with the gateway. The gateway sends information to the client. The client extracts a security configuration from the information sent by the gateway. Using the security configuration, a tunnel between the client and the gateway is established.

Accordingly, a minimal configuration may be defined on a client. A gateway administrator may modify network attributes on the gateway, as well as security policies with respect to peers, users, and groups, without manually conveying the modifications to a client.

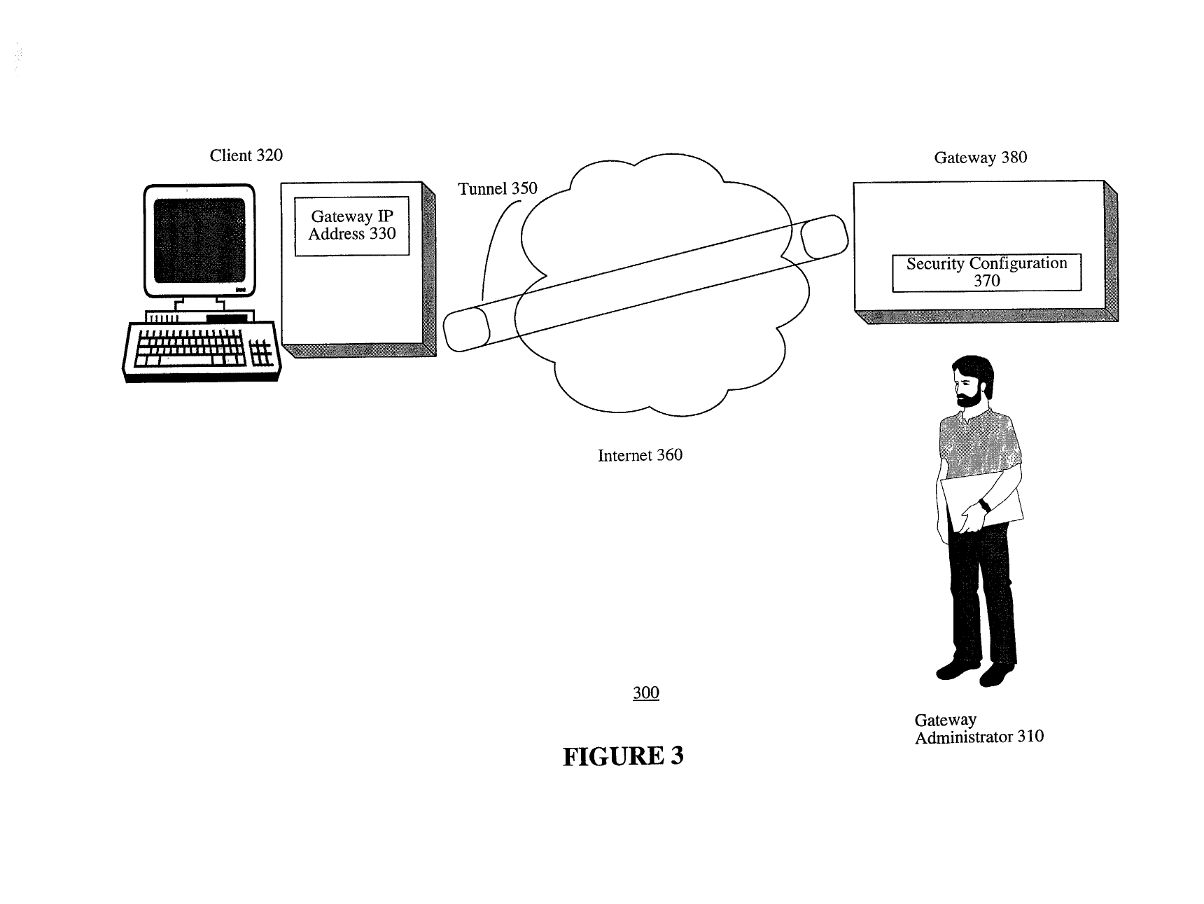

FIG. 3 illustrates system 300 according to an embodiment of the present invention. As shown, system 300 comprises a client 320 and a gateway 380 communicating over the Internet 360. For illustrative purposes, tunnels are shown herein as being formed between clients and gateways. The term “client” corresponds to a first endpoint of a tunnel, and “gateway” corresponds to a second endpoint. These terms may encompass any of a number of devices, such as personal computers, client computers, servers, mainframes, gateways, personal digital assistants (PDAs), other handheld devices, and other computing devices. The terms “first peer” and “second peer” may be substituted for “client” and “gateway.” Additionally, the Internet 360 may be replaced by another network, such as an intranet.

Gateway 380 stores or has access to a security configuration 370, which may comprise security and policy attributes. Such attributes may include security and network parameters and network addresses. Gateway 380 has associated therewith a gateway administrator 310, who may manually modify various parameters within security configuration 370. However, such modifications may also be made automatically via software.

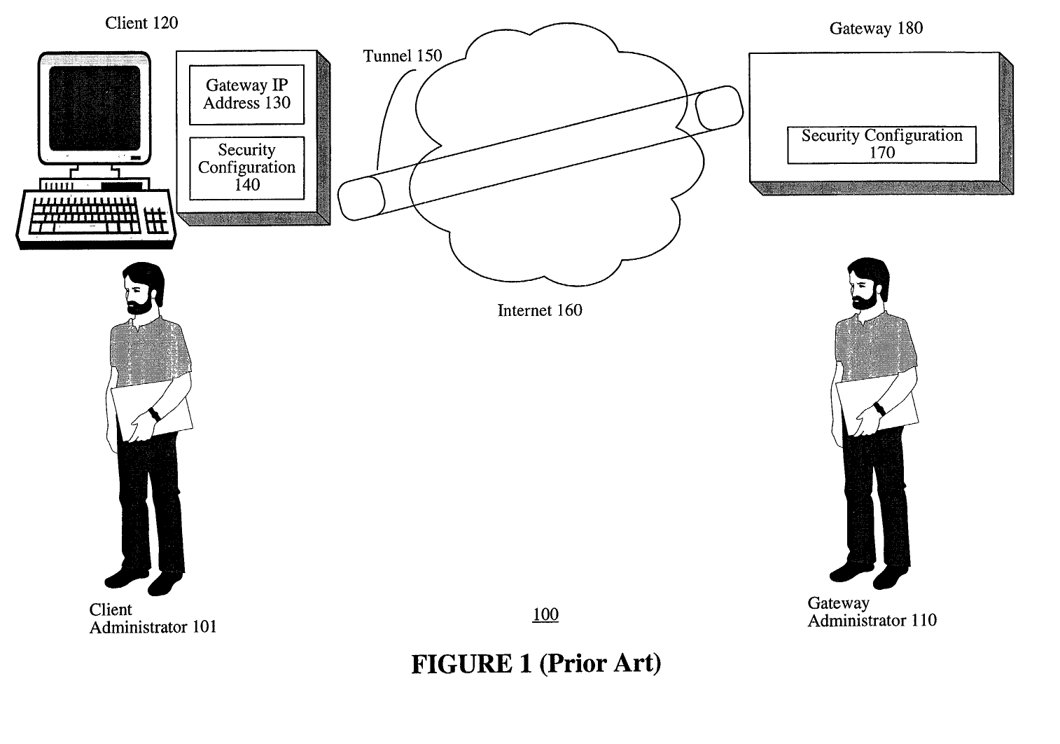

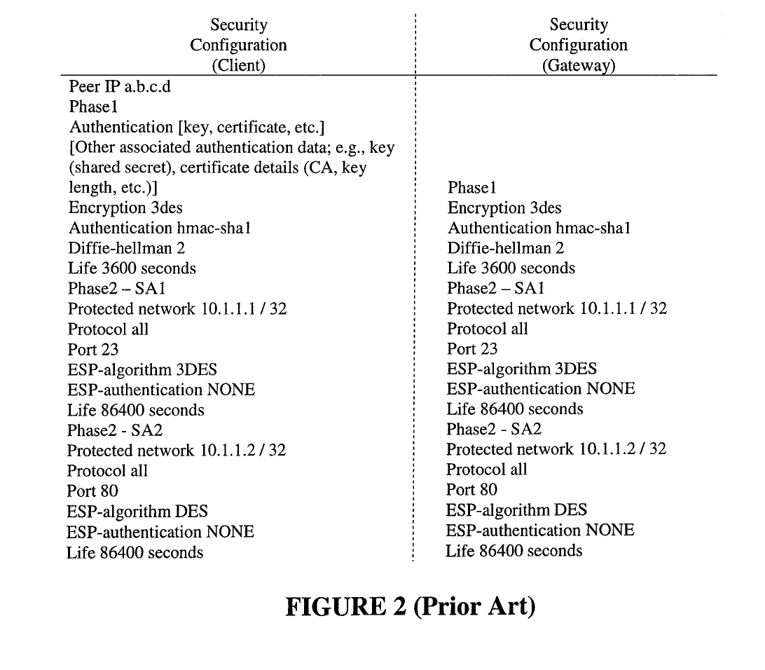

Client 320 does not have an associated administrator such as client administrator 101 in FIG. 1 above. According to embodiments of the present invention, client 320 need not maintain a security configuration corresponding to security configuration 370 of gateway 380.

Client 320 stores, has access to, or receives as input from a user, IP address 330 of gateway 380. Client 320 may maintain IP address 330 and a preshared secret or certificate for authentication. The preshared secret may be known to both client 320 and gateway 380 prior to negotiations which ultimately establish tunnel 350 within Internet 360.

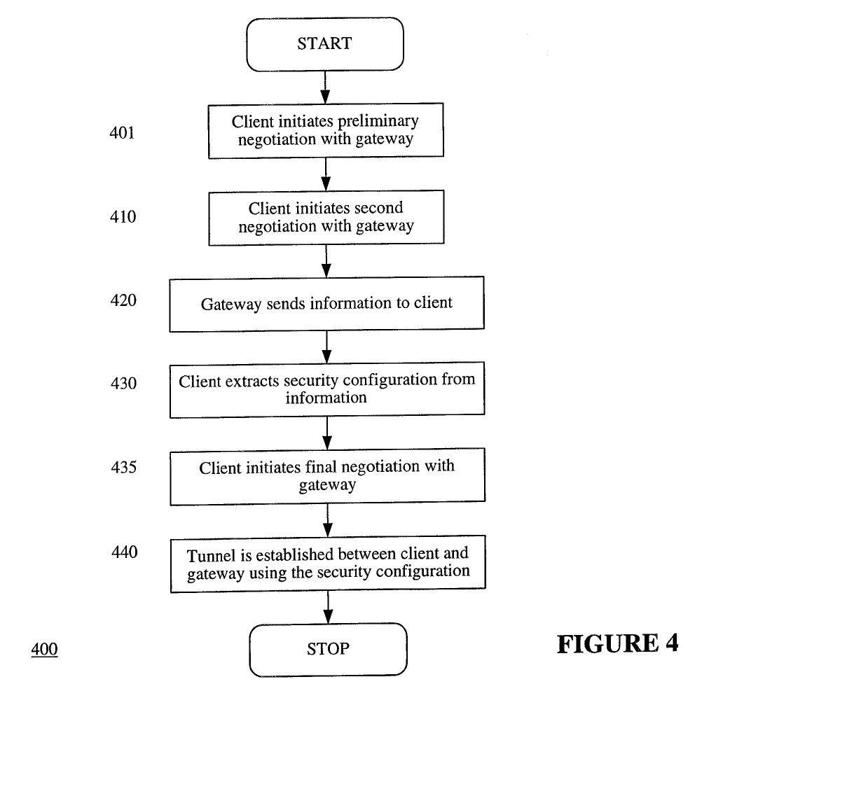

FIG. 4 is a high-level flow diagram of method 400 according to an embodiment of the present invention. It is to be appreciated that method 400 may be implemented using various protocols. Moreover, additional negotiations (not shown) may be included in method 400.

In item 401, a client initiates a preliminary negotiation with a gateway. In item 410, the client initiates a second negotiation with the gateway. In some protocols, one negotiation may be initiated. The gateway sends information to the client in item 420. This information may have been requested by the client in a previous negotiation, such as in the negotiation initiated by the client in item 410. In item 430, the client extracts a security configuration from the information sent by the gateway. In item 435, the client initiates a final negotiation with the gateway. A tunnel providing secure communication between the client and the gateway is established in item 440 using the security configuration.

In item 420 of method 400, the gateway may also send information to the client about one or more protocols, such as the securID, RADIUS, and L2TP protocols. As such, the client may extract the information and use the protocols for additional negotiations. In an exemplary implementation (not shown), a security authentication negotiation may occur before item 435 in FIG. 4.

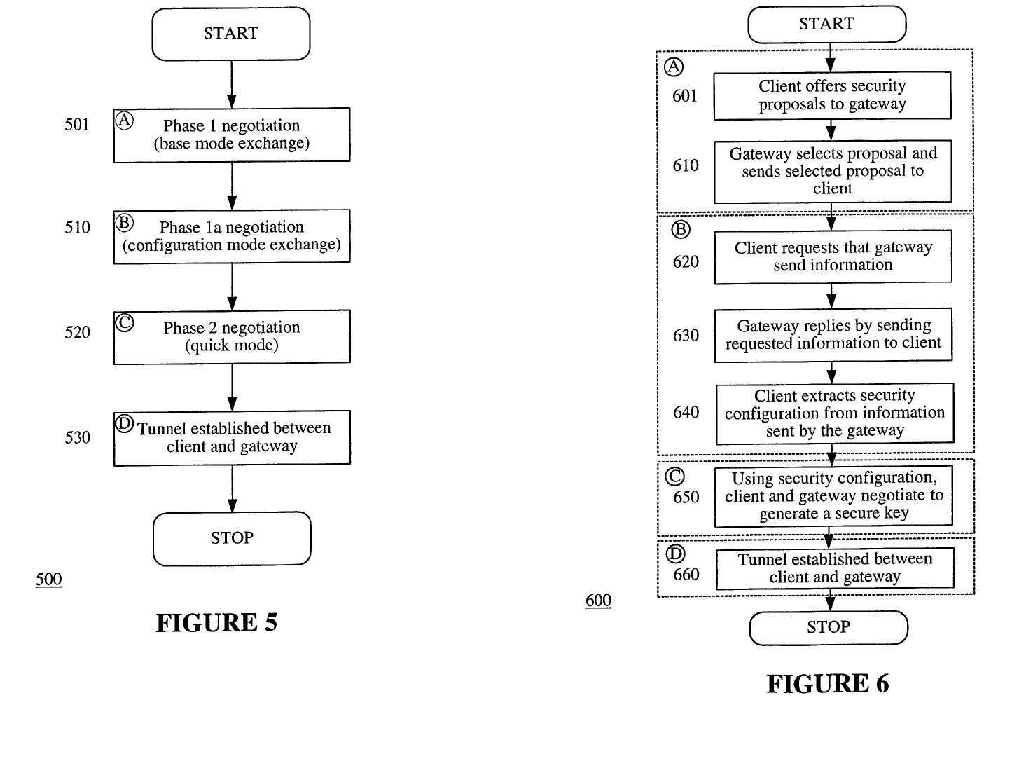

FIG. 5 is a high-level flow diagram of method 500 according to another embodiment of the present invention. In method 500, the IPSec protocol is employed to establish a secure tunnel between a client and a gateway. In item 501, a phase1 negotiation occurs. The negotiation is described in further detail below. Phase1 negotiation may be effectuated using the Base Mode Exchange extension of the IPSec protocol, Internet Draft draft-ietf-ipsec-ike-base-mode-02.txt, as well as with Main Mode and Aggressive Mode, RFC 2409. As a result of phase1 negotiation, the client and the gateway authenticate each other and agree upon a valid security policy to govern a subsequent negotiation between the client and the gateway.

In item 510, an intermediate negotiation termed “phase1a” herein is initiated between the client and the gateway. In an exemplary implementation, phase1a negotiation utilizes the Configuration Mode Exchange extension, Internet Draft draft-dukes-ike-mode-cfg-00.txt, of the IPSec protocol. As a result of phase1a negotiation, the client receives from the gateway phase2 security parameters needed to negotiate phase2. In exemplary negotiations, the phase1 and phase2 parameters are independent of one another.

Because the client and the gateway now have identical security configurations, phase2 negotiation occurs in item 520. In some embodiments, Quick Mode, RFC 2409, an exchange of the IPSec protocol, may be employed. Assuming that phase2 negotiation succeeds, then the client and the gateway have generated secure keys to govern all subsequent transmissions between the client and the gateway. Therefore, in item 530, a tunnel has been established between the client and the gateway to enable secure communications.

FIG. 6 is a high-level flow diagram of method 600 according to an embodiment of the present invention. The dashed portions of method 600 may correspond to respective items within method 500 of FIG. 5.

Dashed portion A may correspond to phase1 negotiation in item 501. In accordance with the Base Mode Exchange extension of the IPSec protocol, a phase1 initiator may offer to a responder multiple security proposals containing multiple transforms, as well as the identity of the initiator, in the first packet of the negotiation.

In an exemplary implementation, a client may send to a gateway all or some permutations of the security algorithms supported by the client. Further, the proposals may be ordered within the transmitted packet from more to less secure proposals. As such, when the gateway parses these proposals, the more secure proposals may be considered before the less secure proposals. Accordingly, the highest level of security to govern subsequent negotiations may be selected. In addition, because the client offers all of its supported security attributes, phase1 negotiation will succeed—that is, a valid security policy will be matched—so long as the gateway supports at least one set of the proposed policies. Therefore, phase1 negotiation may occur successfully without the client storing, having access to, or receiving as input from a user, the security parameters the client must match for phase1 negotiation.

More specifically, in item 601 of FIG. 6, a client offers security proposals to a gateway when the client initiates a preliminary negotiation. In item 610, the gateway selects a proposal among the proposals offered by the client that matches a proposal supported by the gateway. The gateway may then send the selected proposal back to the client.

Dashed portion B of method 600 may correspond to phase1a negotiation in item 510 of FIG. 5. Configuration Mode Exchange of the IPSec protocol is based on a general request/reply protocol. An initiator makes a request of a responder, and the responder replies by sending back requested information to the initiator.

According to an embodiment of the present invention, the Configuration Mode Exchange extension is enhanced to include an additional set of attributes. In particular, the attributes include security attributes defining one or more phase2 security or policy associations. An initiator client needing configuration information requests that the responder gateway send all defined phase2 policies. Depending upon the configuration defined on the responder gateway, additional IPSec-related attributes and proprietary attributes may be sent by the gateway. The security attributes may also be sent along with traffic protected by each security association (SA). The phase2 security attributes may be designated with a prefix, such as “CFG_”, so as to distinguish them from other information.

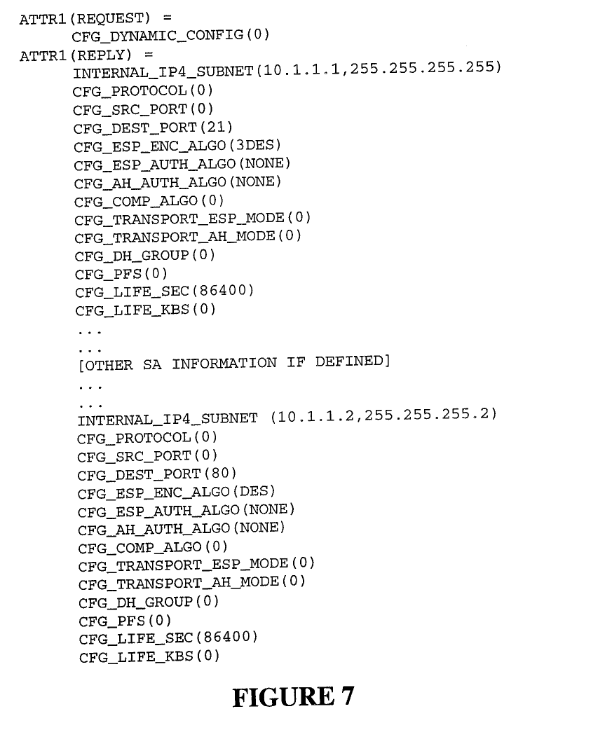

Once the client extracts the security configuration, including, for example, security and network parameters and identities, the client can use the configuration to initiate negotiations for all phase2 security associations defined on the gateway. Negotiations may succeed because attributes now known by the client match attributes defined on the gateway. In some embodiments, if the client already has phase2 policy definitions at the time the client initiates the negotiation, then the definitions are not used or are overwritten by software. In other embodiments, parameters evaluating to zero are not sent by the gateway in its reply to the client's request. Additionally, the number of iterations through each set of parameters may depend on the configuration of the client receiving the parameters. FIG. 7 illustrates an exemplary Configuration Mode Exchange transaction between a client and a gateway.

Specifically, in item 620 of FIG. 6, the client requests that the gateway send information, including all or some defined phase2 policies. In item 630, the gateway replies by sending the requested information back to the client. The information may be sent back in the form of sets of attributes, wherein each set contains sufficient information to define an IPSec security association. An attribute may be omitted from a given set, which may indicate that no value exists for that attribute, that is, the attribute is not used. The number of sets of attributes returned by the gateway may be dictated by the configuration of the responder. In item 640, the client extracts security configuration information from the information sent by the gateway.

Dashed portion C may correspond to phase2 negotiation in item 520 of FIG. 5. In item 650, using the security configuration received by the client, the client and the gateway may negotiate phase2 security associations to generate secure keys. Differing levels of security may be applied to each SA. As such, multiple SAs may be used to enable a client to access multiple resources or services on a protected network. In item 660, a tunnel is established between the client and the gateway so that secure communications may occur between the client and the gateway.

The foregoing description of the preferred embodiments is provided to enable any person skilled in the art to make or use the present invention. Various modifications to these embodiments are possible, and the generic principles presented herein may be applied to other embodiments as well. For instance, the IPSec protocol may continue to evolve, and various new or modified exchanges or extensions may be utilized to implement the present invention. Newly developed protocols may also be suitable. In other embodiments, a gateway may respond to a client by sending an IP address and security configuration of a second client or gateway. As such, a tunnel between the client and the second client or gateway may be established. In still other embodiments, a tunnel may be established between a first gateway and a second gateway.

Moreover, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for dynamically configuring a tunnel comprising:
initiating, by a first peer, a negotiation with a second peer;
sending, by the second peer, information to the first peer;
extracting, by the first peer, a security configuration from the information sent by the second peer; and
establishing, using the security configuration, a tunnel between the first peer and the second peer.

2. The method of claim 1, wherein the negotiation utilizes the configuration mode exchange extension of the IPSec protocol.

3. The method of claim 1, wherein the establishing a tunnel includes conducting a phase2 negotiation in the IPSec protocol.

4. The method of claim 1, further comprising initiating, by the first peer, a preliminary negotiation with the second peer.

5. The method of claim 4, wherein the initiating a preliminary negotiation includes conducting a phase1 negotiation in the IPSec protocol.

6. A method for dynamically configuring a tunnel comprising:
initiating, by a first peer, a negotiation with a second peer;
extracting, by the first peer, a security configuration from information sent by the second peer; and
establishing, using the security configuration, a tunnel between the first peer and the second peer.

7. The method of claim 6, wherein the tunnel is an IPSec tunnel.

8. The method of claim 6, wherein the negotiation utilizes the configuration mode exchange extension of the IPSec protocol.

9. The method of claim 6, wherein the initiating comprises requesting, by the first peer, that the second peer send information, the information including policy information to define a subsequent negotiation between the first peer and the second peer.

10. The method of claim 9, wherein the policy information defines one or more security associations.

11. The method of claim 10, wherein the information sent by the second peer comprises sets of attributes, the attributes including security parameters and network addresses.

12. The method of claim 6, wherein the establishing a tunnel comprises negotiating, by the first peer with the second peer, to generate a secure key.

13. The method of claim 12, wherein the negotiating to generate a secure key includes conducting a phase2 negotiation in the IPSec protocol.

14. The method of claim 6, wherein the establishing a tunnel utilizes the quick mode exchange of the IPSec protocol.

15. The method of claim 6, wherein the IP address of the second peer is accessible to the first peer.

16. The method of claim 15, wherein a shared secret is stored on the first peer before the negotiation.

17. The method of claim 6, further comprising initiating, by the first peer, a preliminary negotiation with the second peer, the initiating comprising offering, by the first peer to the second peer, at least one security proposal supported by the first peer.

18. The method of claim 17, wherein the first peer orders offered security proposals in a transmission packet such that a more secure security proposal is offered before a less secure proposal.

19. The method of claim 17, wherein the preliminary negotiation utilizes the base mode exchange extension of the IPSec protocol.

20. The method of claim 17, wherein the initiating a preliminary negotiation further comprises sending, by the first peer to the second peer, the identity of the first peer.

21. The method of claim 17, wherein the initiating a preliminary negotiation includes conducting a phase1 negotiation in the IPSec protocol.

22. The method of claim 17, wherein the preliminary negotiation utilizes one of main mode and aggressive mode of the IPSec protocol.

23. A method for dynamically configuring a tunnel comprising:
sending, by a second peer, information to a first peer that initiated a negotiation with the second peer, the information including a security configuration intended to be extracted by the first peer; and
establishing, using the security configuration, a tunnel between the first peer and the second peer.

24. The method of claim 23, wherein the information includes policy information defining one or more security associations.

25. A system for dynamically configuring a tunnel comprising:
a first peer; and
a second peer configured to communicate with the first peer over a network connection,
wherein the first peer is configured to initiate a negotiation with the second peer,
the second peer is configured to send information to the first peer,
the first peer is configured to extract a security configuration from the information sent by the second peer, and
the first peer and the second peer are configured to establish a tunnel therebetween using the security configuration.

26. The system of claim 25, wherein the tunnel is an IPSec tunnel.

27. A computer-readable medium encoded with a plurality of processor-executable instruction sequences for:
initiating, by a first peer, a negotiation with a second peer;
extracting, by the first peer, a security configuration from information sent by the second peer; and
establishing, using the security configuration, a tunnel between the first peer and the second peer.

28. The computer-readable medium of claim 27, wherein the negotiation comprises a request/reply negotiation, wherein the first peer requests that the second peer send the information, and the second peer replies to the request by sending the information to the first peer.

29. A computer-readable medium encoded with a plurality of processor-executable instruction sequences for:
sending, by a second peer, information to a first peer that initiated a negotiation with the second peer, the information including a security configuration intended to be extracted by the first peer; and
establishing, using the security configuration, a tunnel between the first peer and the second peer.

30. The computer-readable medium of claim 29, wherein the information includes sets of attributes, the attributes including security parameters and network addresses.
